(19) United States
(12) Patent Application Publication
(10) Pub. No.: US 2009/0092338 A1
(43) Pub. Date: Apr. 9, 2009

(54) Method And Apparatus For Determining The Direction of Color Dependency Interpolating In Order To Generate Missing Colors In A Color Filter Array

(76) Inventor: Jeffrey Matthew Achong, Brampton (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/868,182

(22) Filed: Oct. 5, 2007

(51) Int. Cl. G06K 9/32

(52) U.S. Cl. 382/300

(57) ABSTRACT

A method of determining an interpolation direction used to generate missing colors in a color filter array comprising red, green and blue photosites, comprises for each red and each blue photosite, examining adjacent photosites in each of a plurality of directions and generating for each direction a score representing the distance a significant intensity change is from the photosite, and selecting as the interpolation direction for each respective red and blue photosite, the direction corresponding to the highest score.

### FIELD OF THE INVENTION

The present invention relates generally to image processing and more particularly, to a method and apparatus for determining the direction of color dependency interpolation in order to generate missing colors in a color filter array.

### BACKGROUND OF THE INVENTION

Digital cameras and other image capture devices employ image sensors, such as charge coupled devices (CCDs), complementary metal oxide semiconductor (CMOS) devices or Foveon sensors, to digitally capture images for subsequent storage and display. A typical CCD or CMOS color image sensor in an image capture device comprises a grid or array of photosensitive locations commonly referred to as photosites. During image capture of a scene, each photosite is capable of sensing only a single green, red or blue color. The resulting digital image data forms a pattern (or “mosaic”) of red, green and blue colors known as a color filter array (CFA). In order to reproduce the scene on a visual display in proper color, each pixel in the visual display requires full color information. As will be appreciated, the CFA is therefore missing information required to reproduce the scene in proper color.

To produce a full color image from a CFA, green, red and blue colors must be interpolated at photosites at which they are missing (i.e., have not been sensed), using sensed colors at local photosites. The process of interpolating the missing colors in a CFA is known as de-mosaicing.

The Bayer pattern, a well-known CFA, is a two-by-two array of colors half of which are green, a quarter of which are red, and a quarter of which are blue. Rows of the Bayer CFA have alternating green and red photosites, or alternating green and blue photosites, whereby the green photosites in the Bayer CFA are distributed in a quincunx pattern. Methods for de-mosaicing the Bayer CFA and other CFAs are very well documented. For example, U.S. Patent Application Publication No. 2005/0146629 to Muresan discloses an edge-directed de-mosaicing algorithm. An interpolation direction is estimated using the green channel of a captured CFA by determining interpolation errors in each of the North-South, East-West, North-East and North-West directions and choosing the interpolation direction based on the minimum interpolation error. Interpolation errors are calculated between different ones of the red, green and blue channels on the basis that object boundaries are the same in all three color planes and therefore, all color planes can be used in combination to determine an interpolation direction.

U.S. Pat. No. 6,496,608 to Chui discloses an image data interpolation system and method that employs finite impulse response (FIR) filters. Based on a subset of captured Bayer CFA values, a pixel filling equation is used to ensure smoothness, low distortion and continuous surfaces.

U.S. Pat. No. 6,816,197 to Keshet et al. discloses a method for demosaicing a CFA using bilateral filtering to preserve intensity transitions. Interpolations among neighboring pixels in a mosaic pattern of color pixels are based upon factors that include the relative position and photometric similarities of pixel values within a window that is intensity insensitive. In other words, intensity values of pixels that are physically close are given greater weight than intensity values of more distant pixels and, simultaneously, intensity values that are quantitatively similar are given greater weight than intensity values that are quantitatively dissimilar. By reducing the effect of pixels on one side of an abrupt intensity transition on the interpolated intensity values on the opposite side of the abrupt intensity transition, the sharpness of the transition is enhanced in the reconstructed image. During bilateral filtering, a similarity function that is indicative of the photometric similarity among intensity values of neighboring pixels is algorithmically combined with the determinations of the relative position of the neighboring pixel locations.

U.S. Patent Application Publication No. 2002/0167602 to Nguyen discloses a method for demosaicing image data captured using a Bayer CFA to reduce interpolation artifacts along feature edges. Color discontinuities are equalized on the assumption that the changes in the local color intensity values relative to a local average are the same for each of the red, green and blue color components.

U.S. Patent Application Publication No. 2003/0016295 to Nakakuki discloses an image signal processor that suppresses the occurrence of Moiré noise during interpolation of colors from a Bayer CFA by attenuating each of the color channel signals at one-half of a horizontal sampling frequency.

U.S. Patent Application Publication No. 2003/0231251 to Tsukioka discloses an imaging apparatus that includes a single chip image sensor with a color filter array that is capable of intermittent readout operations in horizontal and vertical directions. An intermittence control means controls the intermittent readout of the image sensor. An interpolation means for processing signals read out from the image sensor in a thinned out pattern designated by the intermittent control means, forms a reduced image consisting of trichromatic components.

U.S. Patent Application Publication No. 2005/0174441 to Acharya et al. discloses a color filter array (CFA) that simplifies the process of interpolating unsensed color values. The CFA comprises more than half green sensors, thereby enabling an interpolation scheme to more accurately result in a full green channel. Edge zones, smooth zones and stripe zones are computed by determining variants of values in localized 3×3 arrays of pixels. Interpolation is conducted based on a determination of the type of zone.

U.S. Patent Application Publication No. 2005/0201616 to Malvar et al. discloses a gradient-corrected linear interpolation method for demosaicing color images. During the method, an interpolation is performed and a correction term is computed based on the gradient of the desired color at a given pixel. The interpolation and correction terms are linearly combined to produce a corrected color. A gradient-correction gain may be applied to the gradient correction term in order to affect the amount of gradient correction applied to the interpolation.

U.S. Patent Application Publication No. 2005/0030409 to Matherson et al. discloses a device containing a two-dimensional photosensor array that generates data representative of the image while an optical element that is interposed between the photosensor array and the light source is moving. The method of blurring the image captured by the photosensor effectively high-pass filters the image, thereby attenuating the effects of aliasing.

U.S. Patent Application Publication No. 2005/0276475 to Sawada discloses an iterative method for generating an output color image from an input color filter array (CFA). During the method, an input image representing the CFA pattern is used to generate a second image as an estimated image of the CFA image. The second image is compared to the first image and a penalty is computed. The penalty is used to correct the estimated image and the correction is applied iteratively.

U.S. Patent Application Publication No. 2006/0012841 to Tsukioka discloses an image processing apparatus that computes a full color image from an image captured by a Bayer CFA. A weight setting unit sets a weight for each of a plurality of directions starting from a pixel of interest in a predetermined neighborhood. An average value calculation unit calculates a weighted average of values of pixels having a specific color component and located in each direction in the predetermined neighborhood by using the respective weights of the pixel values. A restoration unit causes the average calculation unit to calculate weighted averages. The weighted averages and respective intensity values of the pixels are used to restore a value of an omitted (i.e. unsensed) color component of the pixel of interest.

U.S. Patent Application Publication No. 2006/0022997 to Spampinato et al. discloses a method for interpolating unsensed pixels in a color filtered input image using data-dependent triangulation. Red, green and blue pixels in respective ones of the three color channels are linked as vertices of triangles, and each unsensed pixel value to be determined is calculated through a linear interpolation of the vertices of its pertinent triangle.

U.S. Patent Application Publication No. 2006/0023089 to Kobayashi discloses a method and apparatus for converting motion image data output from a single-plate solid-state color image sensor. A spatial decimation process selects one or more representative values for each color component of the color image data and produces spatially decimated data composed of selected representative values.

While methods of interpolating missing colors in CFAs are well documented, the prior art reference discussed above disclose techniques that tend to suffer from degradation in image quality. Degradation is caused by inaccuracies due to the selection of a sub-optimal interpolation direction or the introduction of artifacts during interpolation. Furthermore, many of the prior art techniques discussed above require complex and costly processing for second or higher order computation. Improvements are therefore desired.

It is therefore an object to provide a novel method and system for determining the direction of color dependency interpolation in order to generate missing colors in a color filter array.

### SUMMARY OF THE INVENTION

Accordingly in one aspect there is provided a method of determining an interpolation direction used to generate missing colors in a color filter array comprising red, green and blue photosites, said method comprising:

for each red and each blue photosite, examining adjacent photosites in each of a plurality of directions and generating for each direction a score representing the distance a significant intensity change is from the photosite; and

selecting as the interpolation direction for each respective red and blue photosite, the direction corresponding to the highest score.

In one embodiment, during the searching, green photosites that extend away from the selected photosite along multiple strands of photosites in each of the directions are examined. The directions comprise vertical up, vertical down, horizontal left, horizontal right, diagonal right-up, diagonal right-down, diagonal left-up and diagonal left-down directions. The score is based on relative intensities of examined adjacent green photosites. A score for each examined strand of photosites is generated. The scores for the strands in each direction are summed to yield the score for that direction. For each direction, searching along each strand of photosites progresses outwardly until relative intensities of adjacent green photosites are unequal signifying the significant intensity change. The searching along each strand may also be stopped when a search window boundary is reached.

According to another aspect, there is provided a method of interpolating missing colors in a color filter array (CFA) comprising red, green and blue photosites, the method comprising:

determining an interpolation direction for each red and each blue photosite based on edge distance information;

interpolating a green color for each red and each blue photosite in the determined interpolation direction for that photosite;

for each green photosite, interpolating red and blue colors;

for each red photosite, interpolating a blue color in the determined interpolation direction for that photosite; and

for each blue photosite, interpolating a red color in the determined interpolation direction for that photosite.

According to yet another aspect, there is provided a computer readable medium embodying a computer program for determining an interpolation direction used to generate missing colors in a color filter array comprising red, green and blue photosites, the computer program comprising:

computer program code, for each red and each blue photosite, examining adjacent photosites in each of a plurality of directions and generating for each direction a score representing the distance a significant intensity charge is from the photosite; and

computer program code selecting as the interpolation direction for each respective red and blue photosite, the direction corresponding to the highest score.

According to yet another aspect, there is provided an apparatus for interpolating missing colors in a color filter array comprising red, green and blue photosites, comprising:

means for determining an interpolation direction for each red and each blue photosite based on edge distance information;

means for interpolating a green color for each red and each blue photosite in the determined interpolation direction for that photosite;

means for interpolating, for each green photosite, red and blue colors;

means for interpolating, for each red photosite, a blue color in the determined interpolation direction for that photosite; and

means for interpolating, for each blue photosite, a red color in the determined interpolation direction for that photosite score.

According to still yet another aspect, there is provided a computer readable medium embodying a computer program for interpolating missing colors in a color filter array comprising red, green and blue photosites, said computer program comprising:

computer program code determining an interpolation direction for each red and each blue photosite based on edge distance information;

computer program code interpolating a green color for each red and each blue photosite in the determined interpolation direction for that photosite;

computer program code interpolating, for each green photosite, red and blue colors;

computer program code interpolating, for each red photosite, a blue color in the determined interpolation direction for that photosite; and

computer program code interpolating for each blue photosite, a red color in the determined interpolation direction for that photosite.

### BRIEF DESCRIPTION OF THE DRAWINGS

Embodiments will now be described more fully with reference to the accompanying drawings, in which:

FIG. 1 is a diagram of a Bayer color filter array;

FIG. 2 is a flowchart illustrating a method for de-mosaicing a Bayer color filter array (CFA);

FIGS. 3A to 3D are diagrams illustrating the strands of photosites that are searched in horizontal and vertical directions for a selected blue photosite to detect significant intensity changes;

FIGS. 4A to 4D are diagrams illustrating the strands of photosites that are searched in diagonal directions for the selected blue photosite to detect significant intensity changes;

FIG. 5 is a flowchart illustrating the steps performed in order to generate a score for a vertical or horizontal direction representing the distance a significant intensity change is from a selected red or blue photosite;

FIGS. 6A and 6B are diagrams illustrating the green photosites along a center strand in the horizontal right direction that are progressively examined to detect significant intensity changes;

FIGS. 7A and 7B are diagrams illustrating the green photosites along an upper strand in the horizontal right direction that are progressively examined to detect significant intensity changes;

FIG. 8 is a flowchart illustrating the steps performed in order to generate a score for a diagonal search direction representing the distance a significant intensity change is from a selected red or blue photosite;

FIGS. 9A and 9B are diagrams illustrating the green photosites along a center strand in the diagonal right-up direction that are progressively examined to detect significant intensity changes; and

FIGS. 10A and 10B are diagrams illustrating the green photosites along an upper strand in the diagonal right-up direction that are progressively examined to detect significant intensity.

### DETAILED DESCRIPTION OF THE EMBODIMENTS

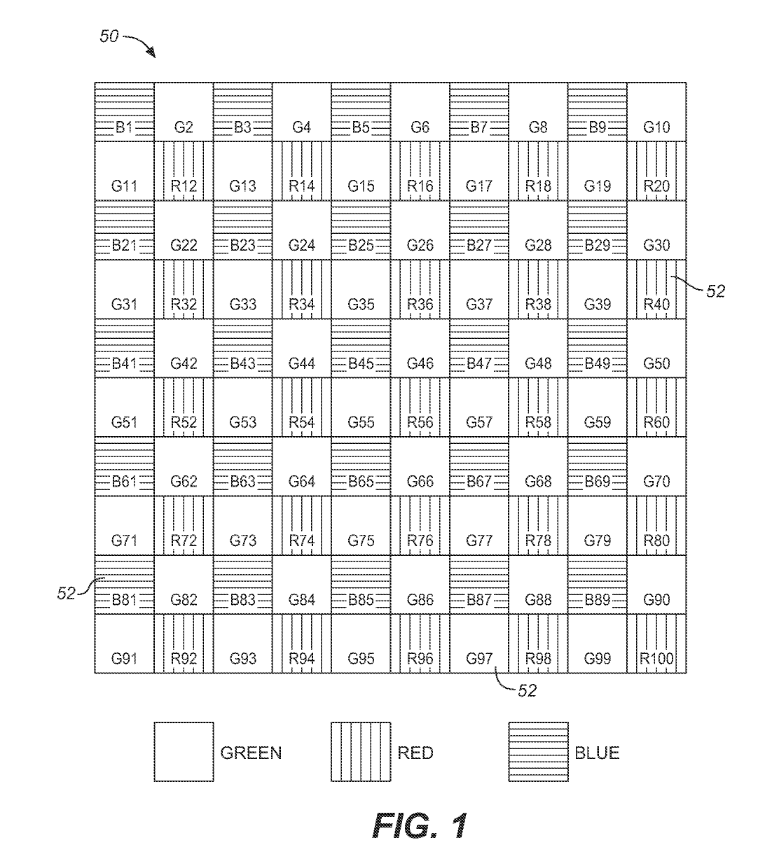

Turning now to FIG. 1, a Bayer color filter array (CFA) 50 comprising a plurality of photosites 52 and an associated legend is shown. Each photosite 52 senses one of red (R), green (G) and blue (B) colors. For ease of discussion, photosites 52 that sense a red color will be referred to as “red” photosites, photosites 52 that sense a green color will be referred to as “green” photosites, and photosites 52 that sense a blue color will be referred to as “blue” photosites. The red, green and blue photosites 52 of the Bayer CFA 50 are alphanumerically identified in order to facilitate the following description. For example, the top left photosite 52 of the Bayer CFA 50 senses a blue color, and is labeled B. The photosite directly to its right senses a green color and is labeled G2. The photosite to the right of photosite G2 senses a blue color and is labeled B3, and so forth. In the next row of the Bayer CFA 50, there are alternating green and red photosites 52 labeled G11, R12, G13, R14, G15 and so forth. As will be appreciated, using this labeling convention each photosite 52 is identified by a unique photosite number, and initially one of R, G and B color designations representing the color the photosite 52 senses.

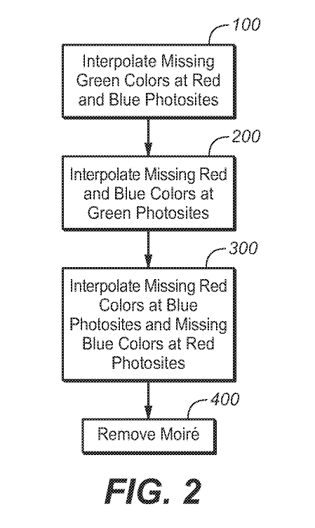

FIG. 2 is a flowchart illustrating the general method for de-mosaicing the Bayer CFA 50 in order to enable a full color image of a captured scene to be produced. During the method, interpolated green colors at red and blue photosites are initially determined (step 100). Interpolated red and blue colors at green photosites are then determined (step 200). Interpolated red colors at blue photosites and interpolated blue colors at red photosites are then determined (step 300) to complete de-mosaicing of the Bayer CFA 50. Moiré is then removed from the de-mosaiced Bayer CFA (step 400). As will be appreciated, the general method is very similar to that disclosed in corresponding U.S. patent application Ser. No. 11/852,144 to Achong et al. filed on Sep. 7, 2007 for an invention entitled “Method and Apparatus for Interpolating Missing Colors in a Color Filter Array” (Attorney Docket No. EETP041), assigned to the assignee of the subject application, the content of which is incorporated herein by reference.

In this embodiment, during interpolation of the missing green color at each of the red and blue photosites, rather than examining local edges proximate the photosite in each of the vertical, horizontal and diagonal directions and designating the direction that yields the strongest local edge as the interpolation direction, as is described in the co-pending Achong et al. application referenced above, the interpolation direction that is selected for each red and blue photosite is based on the distance edges are from the selected photosite. The interpolation direction determined for each red photosite and each blue photosite is used during interpolation of the missing green color at that photosite. The interpolation direction for each red photosite is also used during interpolation of the missing blue color at that photosite and the interpolation direction for each blue photosite is also used during interpolation of the missing red color at that photosite. Further specifics concerning the interpolation direction determination will now be described.

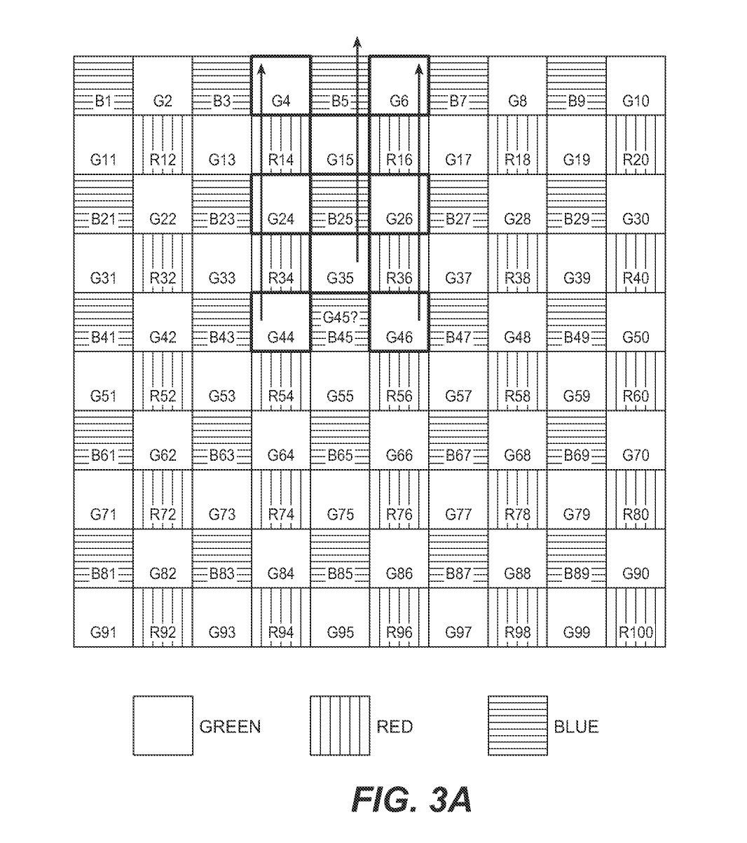

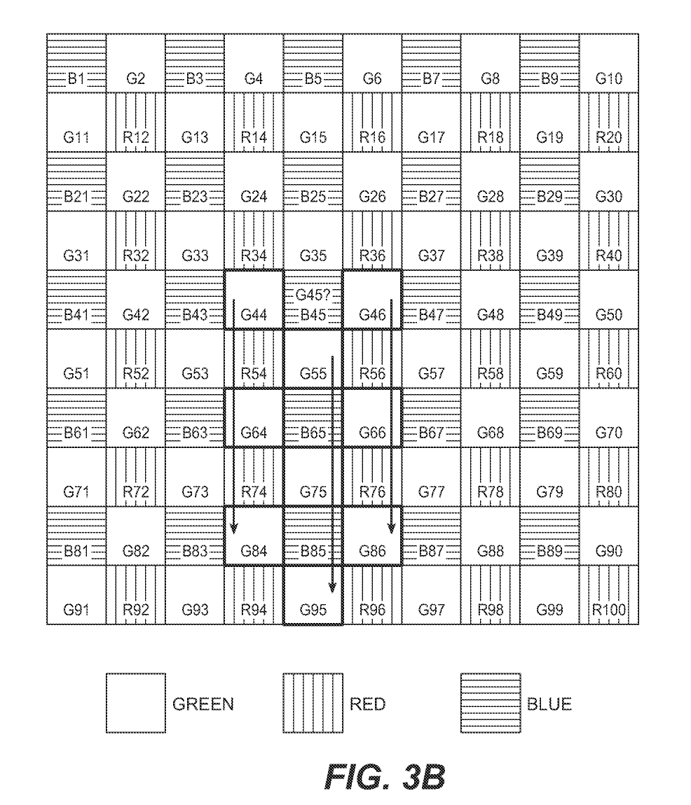

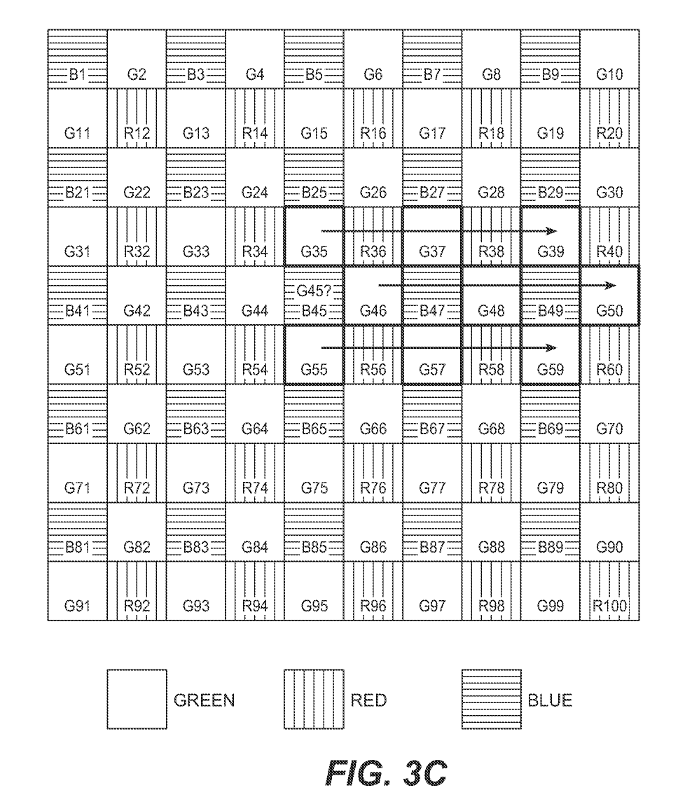

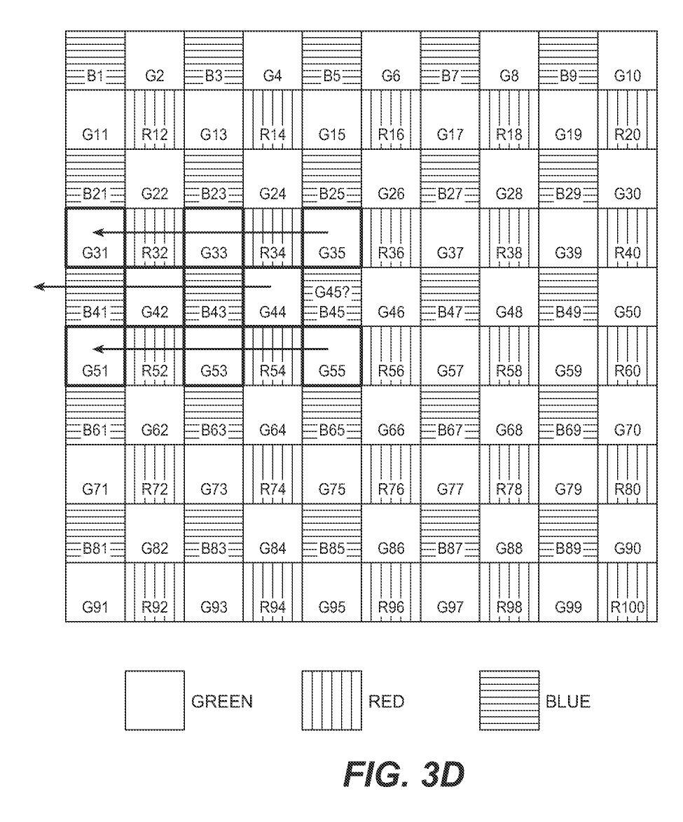

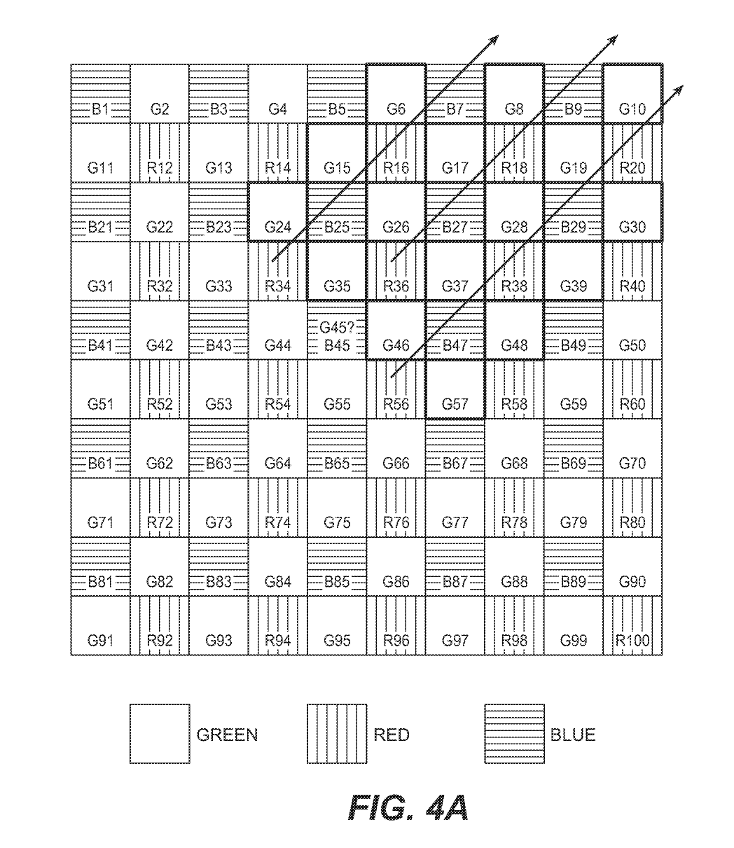

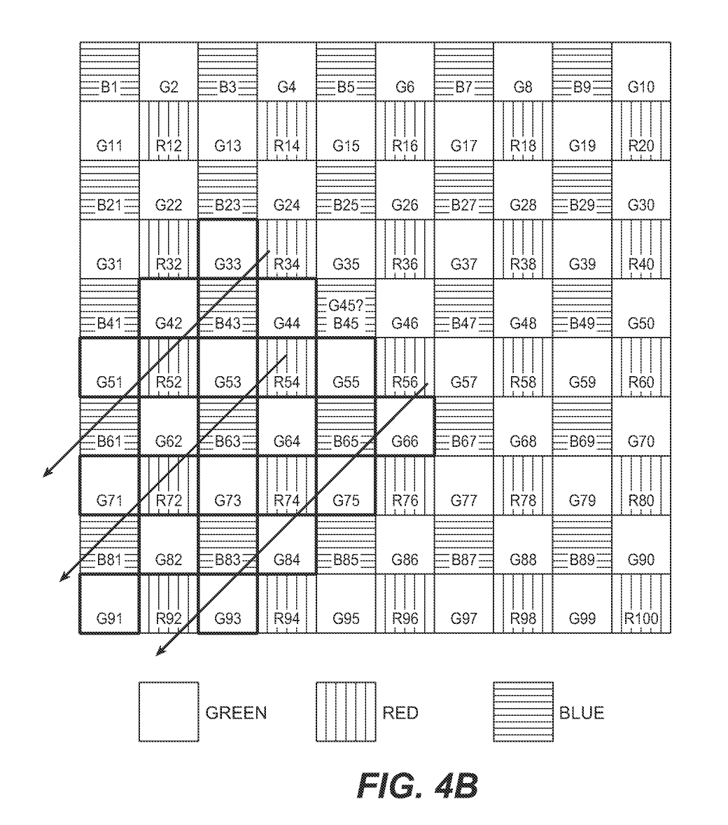

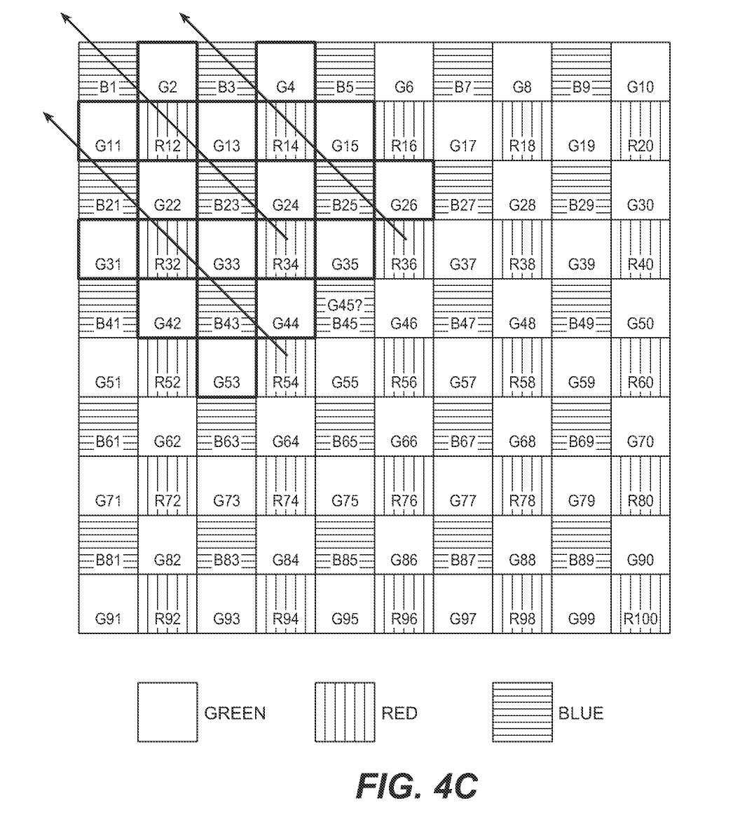

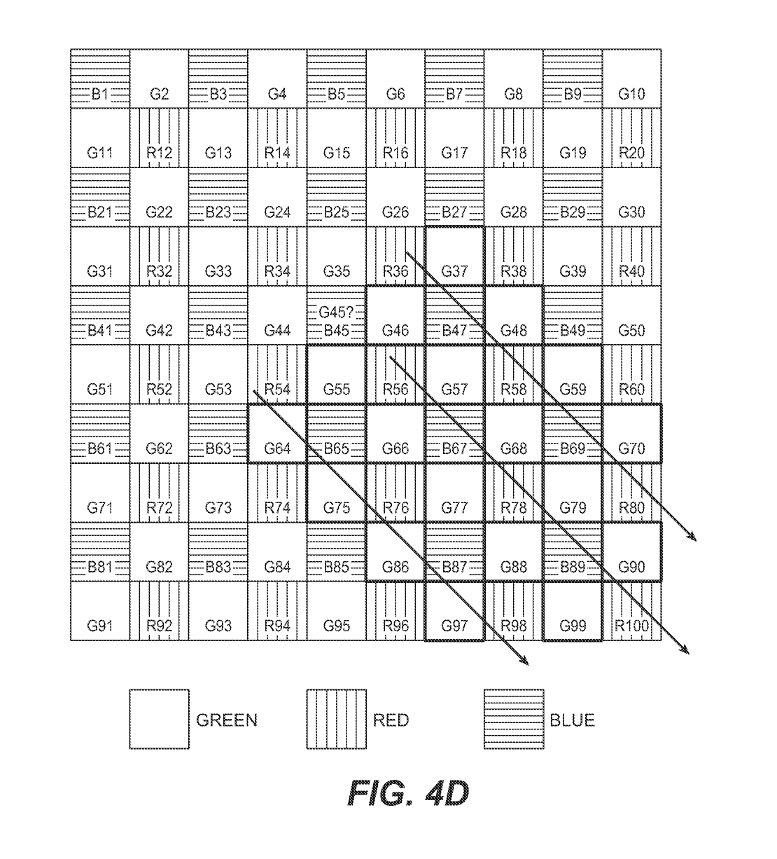

In general, during determination of the interpolation direction for the red and blue photosites, a red or blue photosite is initially selected. Different groups of photosites adjacent the selected photosite in each of the vertical, horizontal and diagonal directions are selected and green photosites therein are examined to detect significant intensity changes signifying the existence of edges. In this embodiment, each group of photosites comprises a plurality of lines or strands of photosites, namely a central strand of photosites that intersects the selected photosite and adjacent strands of photosites that flank the central strand. A search is conducted along the strands of each group and the green photosites of the strands are examined to detect significant intensity changes. For example, during the determination of the interpolation direction for selected blue photosite B45 of the Bayer color filter array 50, the different groups of photosites in the vertical, horizontal and diagonal directions that are searched are shown in FIGS. 3A to 3D and FIGS. 4A to 4D. Scores representing the distance each detected edge is from the selected photosite are generated and examined to detect the score associated with the edge that is furthest from the selected photosite. The search direction that reveals the furthest edge is designated as the interpolation direction.

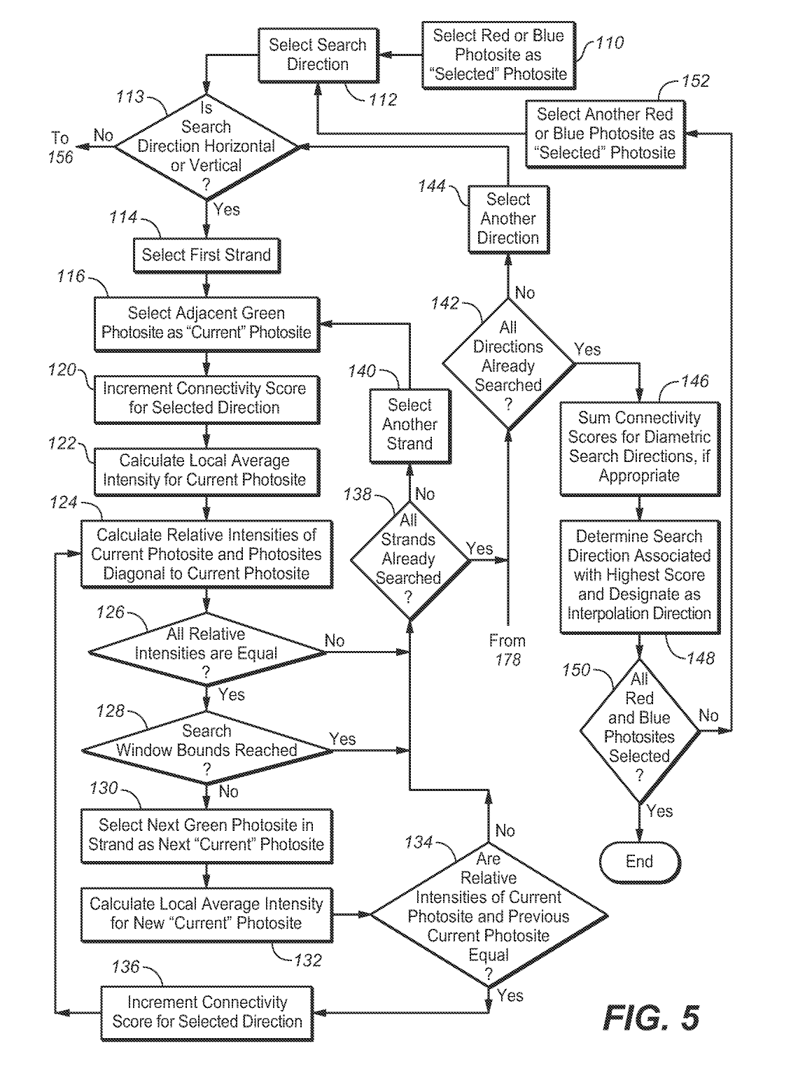

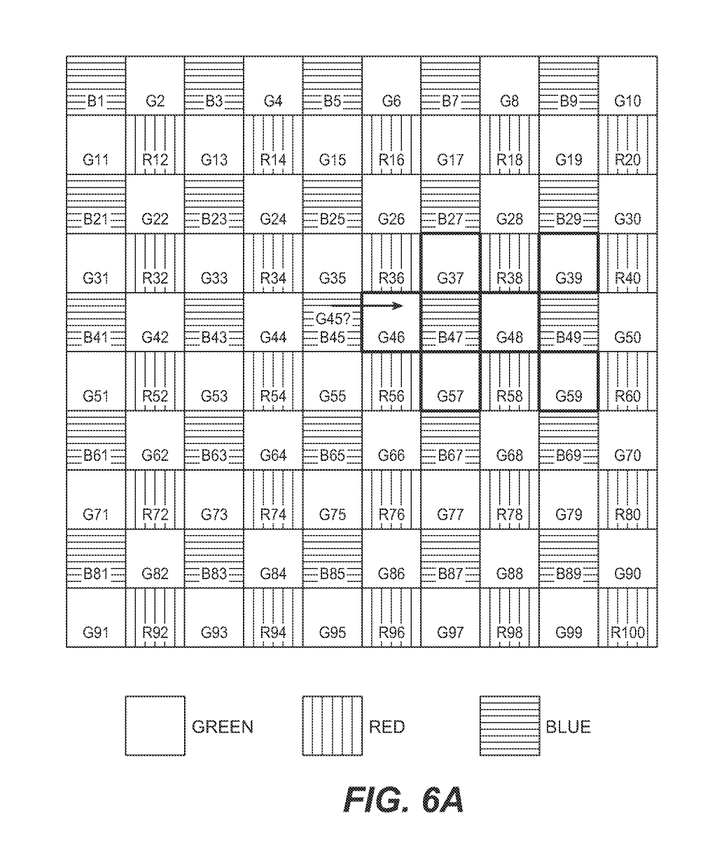

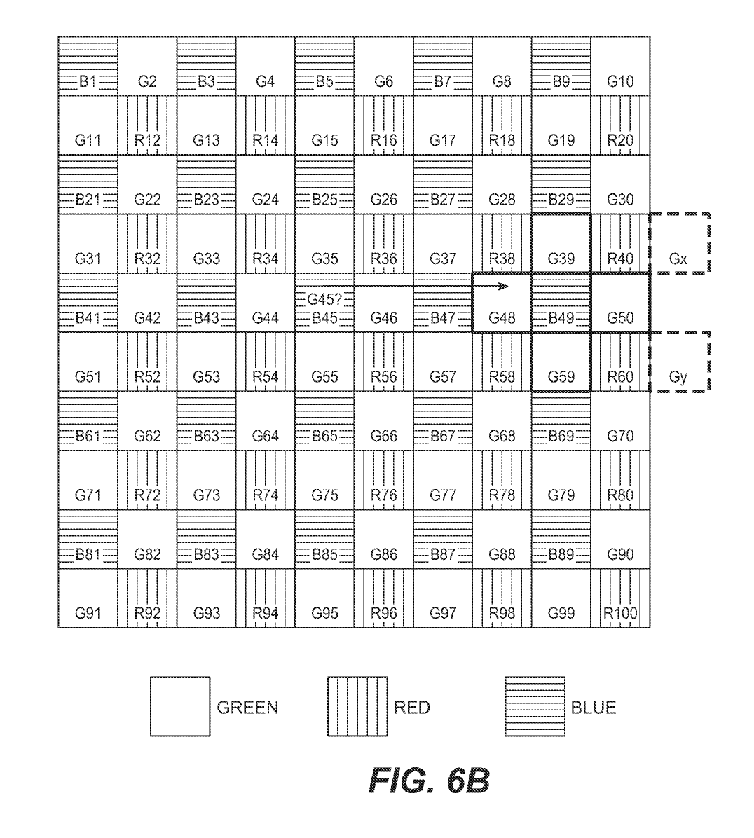

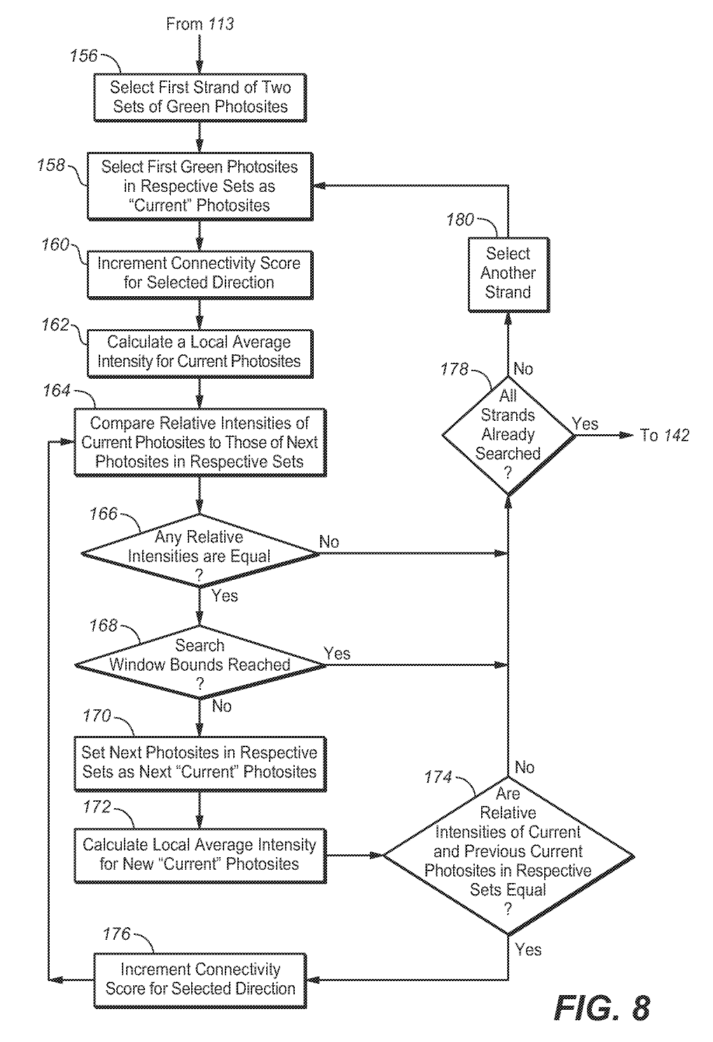

FIGS. 5 and 8 show a flowchart illustrating steps performed in order to generate a score for vertical, horizontal and diagonal search directions representing the distance a significant intensity change is from a selected red or blue photosite. Initially at step 110, a red or blue photosite is selected. One of the horizontal right, horizontal left, upper vertical, lower vertical, diagonal right-up, diagonal right-down, diagonal left-up and diagonal left-down search directions is then selected (step 112). A check is then made to determine if the selected search direction is horizontal or vertical (step 113). If the selected search direction is horizontal or vertical, the central strand of the group of photosites associated with the selected search direction is selected (step 114). The green photosite adjacent the selected photosite in the selected search direction is then identified and designated as the “current” green photosite (step 116). A connectivity score for the selected search direction is then incremented (step 120). For example, FIG. 6A shows the group of photosites associated with the horizontal search direction assuming blue photosite B45 has been selected at step 110. In this case, at step 116, green photosite G46 that is adjacent the selected blue photosite B45 is identified and designated as the current green photosite.

A local average intensity is then calculated for the current green photosite by computing the average intensity of the current green photosite and other local green photosites of the central and flanking strands (step 122). For the selected blue photosite B45, the current green photosite G46 and other local green photosites G37, G39, G57 and G59 used to compute the local average intensity at step 122 are shown in bold in FIG. 6A. Relative intensities for the current green photosite and the proximate diagonal green photosites of the flanking strands are also calculated (step 124). In the example of FIG. 6A, green photosites G37 and G57 are identified at step 124. Each relative intensity is computed by subtracting the average intensity computed at step 122 from the intensity of the current green or proximate diagonal green photosite. The computed relative intensities are then compared (step 126). If at step 126, the calculated relative intensities are determined to be equal, then a check is made to determine if the boundary of a search window has been reached (step 128). The search window is specified based on requirements for accuracy and speed.

If at step 128 it is determined that the boundary of the search window has not been reached, then the next green photosite of the central strand in the selected search direction is selected as the new “current” photosite (step 130). Following the above example, at step 130, green photosite G48 is selected as the new current photosite as shown in FIG. 6B. A new local average intensity is calculated for the new current green photosite based on the new current green photosite and other local green photosites of the central and flanking strands (step 132). For the selected blue photosite B45, the new current green photosite G48 and the other local green photosites G39, Gx, G59 and Gy used to compute the local average intensity at step 132 are shown in bold in FIG. 6B. The relative intensity of the new current green photosite is then compared to the relative intensity computed for the previous current green photosite. If the relative intensities are equal then the previous current and new green photosites are considered to be connected and the connectivity score for the selected search direction is incremented (step 136). The process then reverts back to step 124.

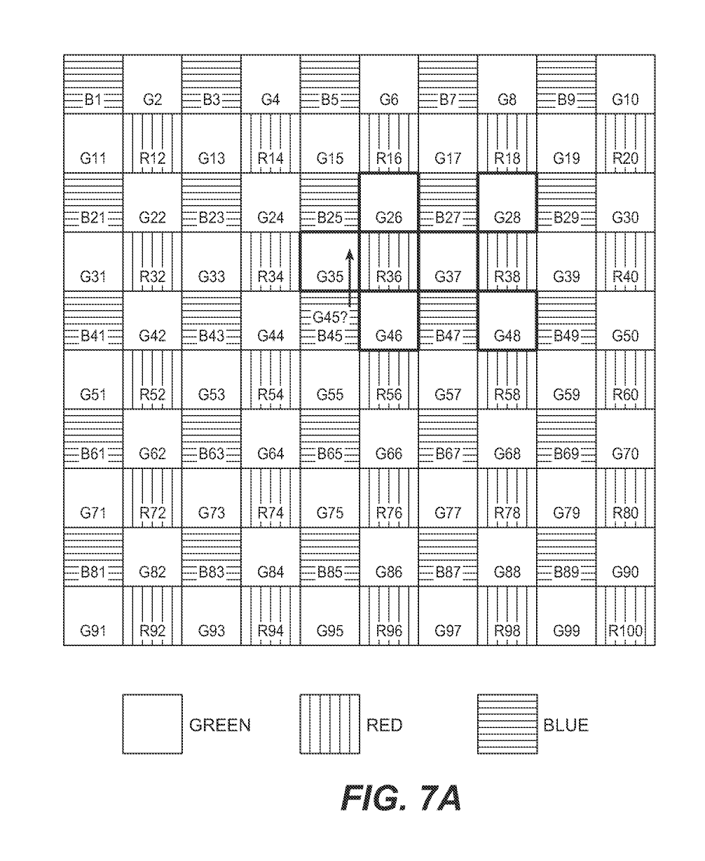

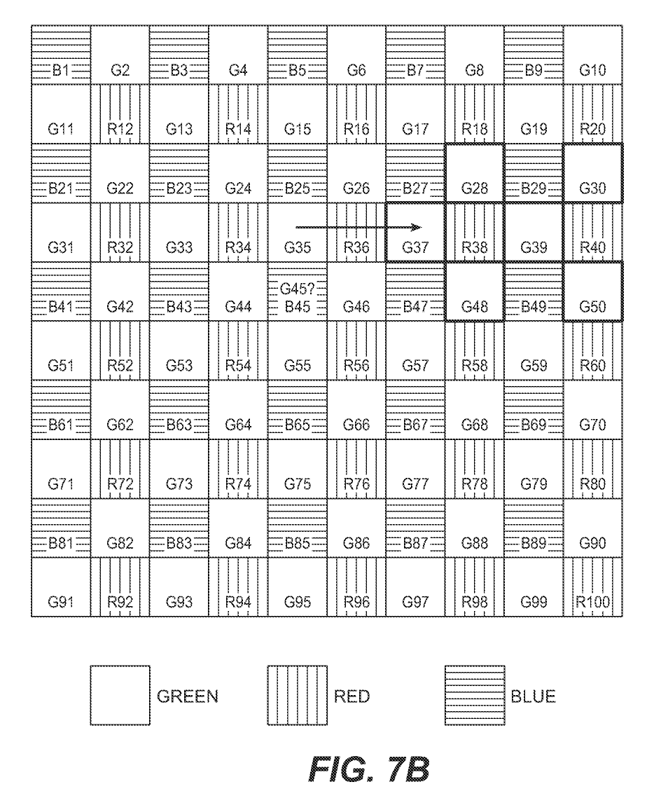

If at step 134 the relative intensities of the new current and previous current green photosites are not equal, or if at step 128, the boundary of the search window has been reached, or if at step 126, the calculated relative intensities are not equal, a check is made to determine if all of the strands of the group of photosites associated with the selected search direction have been selected (step 138). If not, the next strand is selected (step 140) and the process reverts back to step 116. For example, during searching of the upper strand of the group of photosites shown in FIG. 6A, green photosite G35 is selected as the current green photosite at step 116. The current green photosite G35 and the other local green photosites G26, G28, G46 and G48 used to compute the local average intensity at step 122 are shown in bold in FIG. 7A. The new current green photosite G37 for the upper strand selected at step 130 and the other local green photosites G28, G30, G48 and G50 used to compute the local average intensity at step 132 are shown in bold in FIG. 7B. As will be appreciated, steps 116 to 136 are performed for each strand of the group of photosites associated with the selected search direction. As a result, the connectivity score for the selected search direction takes the searches of each strand into account.

At step 138, if all of the strands of photosites of the group have been searched, a check is made to determine if searches have been conducted in each of the horizontal right, horizontal left, upper vertical, lower vertical, diagonal right-up, diagonal right-down, diagonal left-up and diagonal left-down search directions (step 142). If not, the next unselected search direction is selected (step 144) and the process reverts back to step 113.

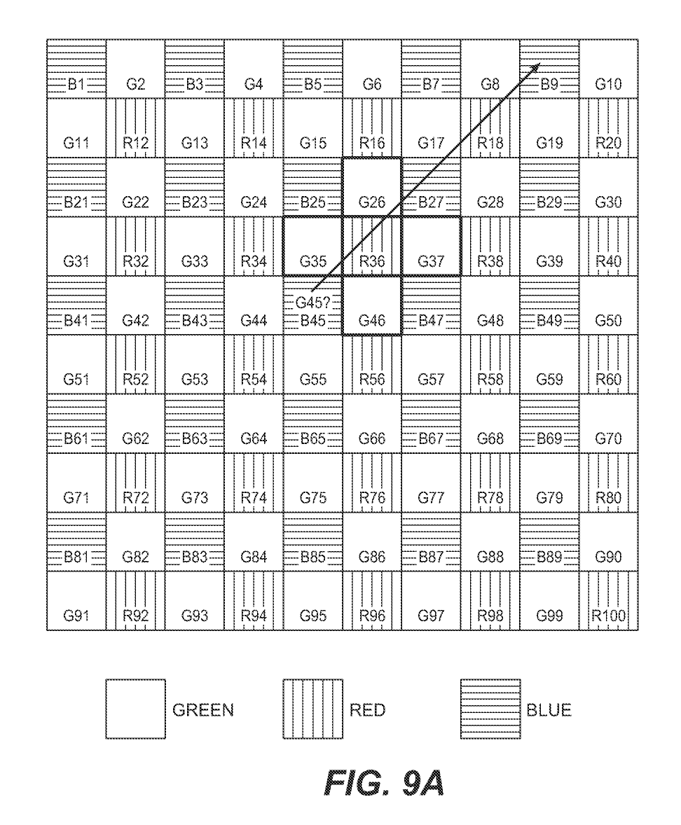

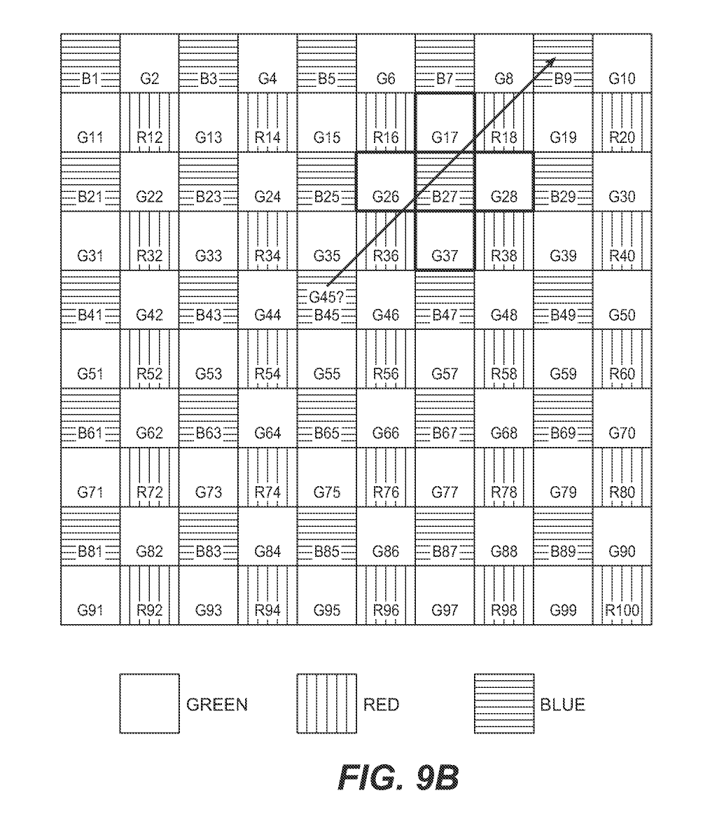

At step 113 if it is determined that one of the diagonal right-up, diagonal right-down, diagonal left-up and diagonal left down search directions has been selected, the strands of green photosites flanking the diagonal strand of photosites, that extends in the selected search direction and intersects the selected photosite, are then identified (step 156 in FIG. 8). The green photosites in the flanking strands that are adjacent the selected photosite are then identified and designated as the “current” green photosites (step 158). A connectivity score for the selected search direction is then incremented (step 160). Again following the above example, for selected blue photosite B45 and a selected diagonal right-up search direction, green photosites G35 and G46 that are diagonally adjacent blue photosite B45 are identified as the current green photosites at step 158 (see FIG. 9A).

A local average intensity is then calculated for the current green photosites by averaging the intensities of the current green photosites and local diagonal green photosites (step 162). For the selected blue photosite B45, the current green photosites G35 and G46 and local diagonal green photosites G26 and G37 used to compute the local average intensity at step 162 are shown in bold in FIG. 9A. Relative intensities are then calculated for each of the current green photosites, as well as for the diagonal local green photosites by determining the difference between their intensities and the local average intensity. The relative intensity of each current green photosite and its adjacent diagonal local green photosite are then compared (step 164).

At step 166 if it is determined that any of the compared relative intensities are equal, a check is made to determine if the boundary of the search window has been reached (step 168). If at step 168 it is determined that the boundary of the search window has not been reached, then the diagonal local green photosites in the strands are designated as the new current green photosites (step 170). Thus in the case of the above example, local green photosites G26 and G37 are designated as the new current green photosites. A new local average intensity is calculated for the new current green photosites by averaging the intensities of the new current green photosites and diagonal local green photosites (step 172). For the selected blue photosite B45, the new current green photosites G26 and G37 and the diagonal local green photosites G17 and G28 used to compute the local average intensity at step 172 are shown in FIG. 9B. The relative intensities for the new current green photosites are then computed in the same manner described above. If the relative intensity of each new current green photosite is equal to that of its associated previous green current photosite, then the new current and previous current green photosites are considered connected and the connectivity score for the selected search direction is incremented (step 176). The process then reverts back to at step 164.

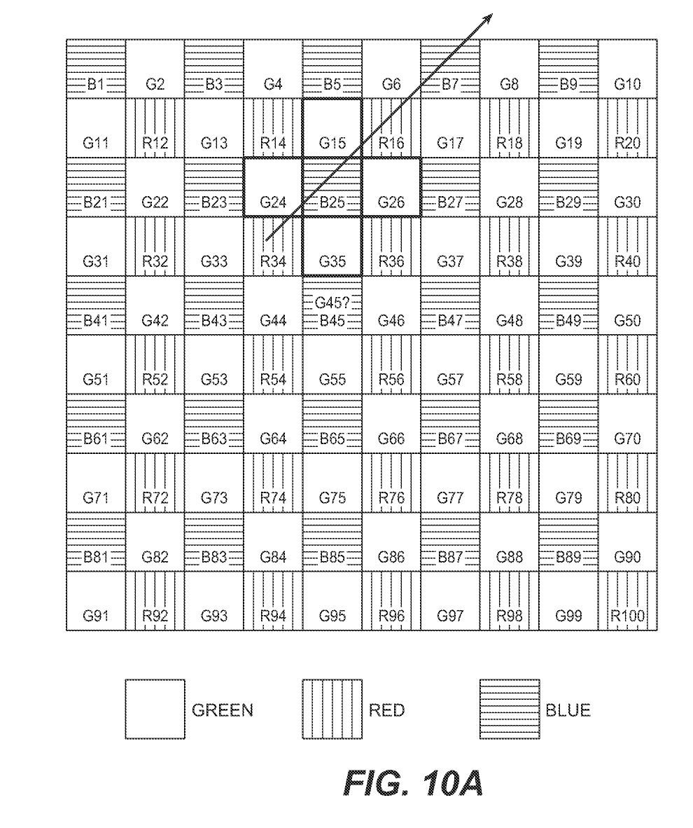

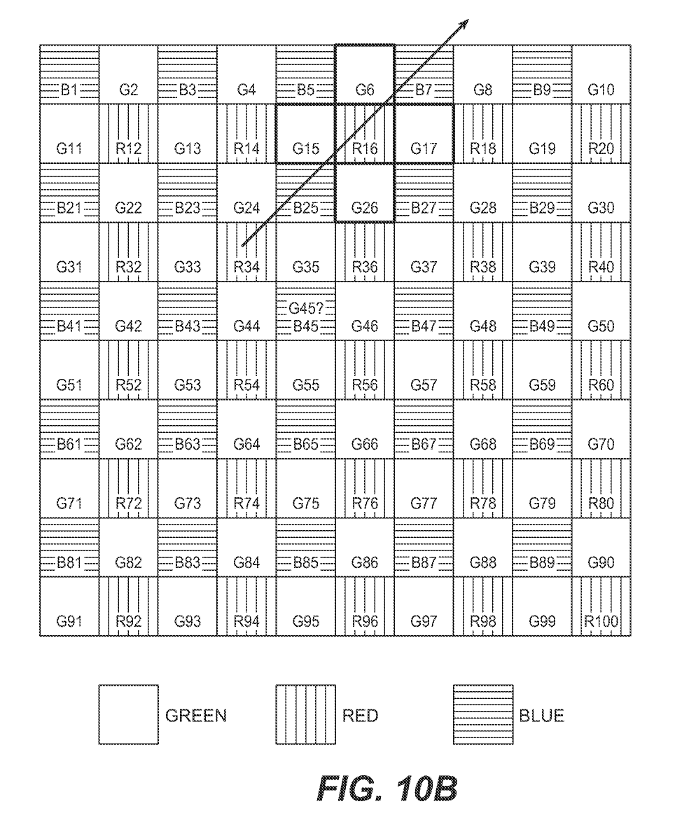

If at step 174 the relative intensities of the current and previous current green photosites are not equal, or if at step 168, the boundary of the search window has been reached, or if at step 166, none of the calculated relative intensities are equal, a check is made to determine if all of the strands of the group of photosites associated with the selected search direction have been selected (step 178). If not, the next strand is selected (step 180) and the process reverts back to step 158. For example, during searching of the upper strand of the group of photosites associated with the diagonal right-up search direction shown in FIG. 9A, green photosites G24 and G35 are selected as the current green photosites at step 156. The current green photosites G24 and G35 and diagonal local green photosites G15 and G26 used to compute the local average intensity at step 162 are shown in bold in FIG. 10A. The new current green photosites G15 and G26 for the upper strand selected at step 170 and the diagonal local green photosites G6 and G17 used to compute the local average intensity at step 172 are shown in bold in FIG. 10B. As will be appreciated, steps 158 to 176 are performed for each strand of the group of photosites associated with the selected search direction.

At step 178, if all of the strands of photosites of the group have been searched, the process reverts to step 142 where a check is made to determine if searches have been conducted in each of the horizontal right, horizontal left, upper vertical, lower vertical, diagonal right-up, diagonal right-down, diagonal left-up and diagonal left-down search directions. The above-described search and connectivity score determination process is performed for each red and each blue photosite of the Bayer CFA 50 thereby to generate connectivity scores for each of the horizontal, vertical and diagonal directions.

If at step 142 it is determined that each of the horizontal, vertical and diagonal search directions for the selected photosite have been searched, searching for the selected photosite is stopped. The connectivity scores computed for search directions that are diametrically opposite the selected photosite (i.e., horizontal right-horizontal left, upper vertical-lower vertical, diagonal right-up-diagonal left-down and diagonal left-up-diagonal right-down) are then summed only if the selected photosite does not lie on an edge boundary that is perpendicular to the search directions (step 146). This is determined by ascertaining whether the magnitudes of the green photosites adjacent the selected photosite in the respective diametric search directions whose scores are to be combined are either both above or both below their respective local intensity averages. Once the connectivity scores have been summed at step 146 if appropriate, the search direction associated with the highest connectivity score is determined and is designated as the interpolation direction for the selected photosite (step 148). A check is then made to determine if all of the red and blue photosites have been selected (step 150). If not, the next red or blue photosite is selected (step 152) and the process reverts back to step 112. In this manner, an interpolation direction based on edge distance information is generated for each red and blue photosite.

Once the interpolation direction has been determined for each red and blue photosite, an interpolated green color is determined for each red and blue photosite using the associated interpolation direction in the manner described in the above-incorporated Achong et al. application. Missing red and blue colors at each green photosite, the missing red color at each blue photosite and the missing blue color at each red photosite are also interpolated in the manner described in the above-incorporated Aching et al. application.

An apparatus comprising an edge detector and multiple interpolators similar to that described in the above-incorporated Achong et al. application receives image data from the Bayer CFA and processes the image data according to the method described above. The edge detector and interpolators may be embodied by the processing unit of an image capture device such as a digital camera, video recorder, scanner, etc. In this case, the processing unit executes a software application that performs the edge detection and interpolation on the sensed image data. The software application may comprise program modules including routines, programs, object components, data structures etc. and may be embodied as computer readable program code stored on a computer readable medium. The computer readable medium is any data storage device that can store data, which can thereafter be read by the processing unit. Examples of computer readable media include for example read-only memory, random-access memory, CD-ROMs, magnetic tape and optical data storage devices.

Although an embodiment has been described, those of skill in the art will appreciate that variations and modifications may be made without departing from the spirit and scope of the invention defined by the appended claims.

What is claimed is:

1. A method of determining an interpolation direction used to generate missing colors in a color filter array comprising red, green and blue photosites, said method comprising:
for each red and each blue photosite, examining adjacent photosites in each of a plurality of directions and generating for each direction a score representing the distance a significant intensity change is from the photosite; and
selecting as the interpolation direction for each respective red and blue photosite, the direction corresponding to the highest score.

2. The method of claim 1, wherein during said searching green photosites that extend away from the selected photosite in each of said directions are examined.

3. The method of claim 2, wherein during said searching green photosites along multiple strands of photosites in each of the directions are examined.

4. The method of claim 3, wherein the plurality of directions comprises vertical up, vertical down, horizontal left, horizontal right, diagonal right-up, diagonal right-down, diagonal left-up, and diagonal left-down directions.

5. The method of claim 4 wherein each score is based on relative intensities of examined adjacent green photosites.

6. The method of claim 5 wherein a score for each examined strand of photosites is generated and wherein the scores for the strands in each direction are summed to yield the score for that direction.

7. The method of claim 6 wherein, for each direction, searching along each strand of photosites progresses outwardly until relative intensities of adjacent green photosites are unequal signifying said significant intensity change.

8. The method of claim 7 wherein searching along each strand is also stopped when a search window boundary is reached.

9. The method of claim 6, further comprising:
for each red and blue photosite, combining scores obtained for pairs of diametrically opposite directions.

10. A method of interpolating missing colors in a color filter array (CFA) comprising red, green and blue photosites, the method comprising:
determining an interpolation direction for each red and each blue photosite based on edge distance information;
interpolating a green color for each red and each blue photosite in the determined interpolation direction for that photosite;
for each green photosite, interpolating red and blue colors;
for each red photosite, interpolating a blue color in the determined interpolation direction for that photosite; and
for each blue photosite, interpolating a red color in the determined interpolation direction for that photosite.

11. The method of claim 10 wherein said interpolation direction for each red and each blue photosite corresponds to the direction along which the furthest edge from the photosite is detected.

12. The method of claim 11, wherein said interpolation direction determining comprises:
for each red and each blue photosite, examining adjacent photosites in each of a plurality of directions and generating for each direction a score representing the distance a significant intensity charge is from the photosite; and
selecting as the interpolation direction for each respective red and blue photosite, the direction corresponding to the highest score

13. The method of claim 12, wherein during said searching green photosites that extend away from the selected photosite in each of said directions are examined.

14. The method of claim 13, wherein during said searching green photosites along multiple strands of photosites in each of the directions are examined.

15. The method of claim 14, wherein the plurality of directions comprises vertical up, vertical down, horizontal left, horizontal right, diagonal right-up, diagonal right-down, diagonal left-up, and diagonal left-down directions.

16. The method of claim 15 wherein each score is based on relative intensities of examined adjacent green photosites.

17. The method of claim 16 wherein a score for each examined strand of photosites is generated and wherein the scores for the strands in each direction are summed to yield the score for that direction.

18. The method of claim 17 wherein, for each direction, searching along each strand of photosites progresses outwardly until relative intensities of adjacent green photosites are unequal signifying said significant intensity change.

19. The method of claim 18 wherein searching along each strand is also stopped when a search window boundary is reached.

20. The method of claim 17, further comprising:
for each red and blue photosite, combining scores obtained for pairs of diametrically opposite directions.

21. An apparatus for interpolating missing colors in a color filter array comprising red, green and blue photosites, comprising:
means for determining an interpolation direction for each red and each blue photosite based on edge distance information;
means for interpolating a green color for each red and each blue photosite in the determined interpolation direction for that photosite;
means for interpolating, for each green photosite, red and blue colors;
means for interpolating, for each red photosite, a blue color in the determined interpolation direction for that photosite; and
means for interpolating, for each blue photosite, a red color in the determined interpolation direction for that photosite.
